(19) United States
(12) Patent Application Publication
(10) Pub. No.: US 2008/0132232 A1
(43) Pub. Date: Jun. 5, 2008

(54) Wireless Communication Terminal

(76) Inventor: Makoto Tomizu, Yokohama-shi (JP)

Correspondence Address: HOGAN & HARTSON L.L.P., 1999 AVENUE OF THE STARS, SUITE 1400, LOS ANGELES, CA, 90067, US

(21) Appl. No.: 10/566,323

(22) PCT Filed: Jul. 27, 2004
(86) PCT No.: PCT/JP04/11018

§ 371 Date: Jan. 16, 2008

(30) Foreign Application Priority Data
Jul. 31, 2003 (JP) 2003-204796

(51) Int. Cl. H04Q 7/20; H04M 1/00

(52) U.S. Cl. 455/436; 455/552.1

(57) ABSTRACT

A wireless communication terminal includes: a plurality of communication sections, each of the communication sections communicating with one of a plurality of communication systems; a threshold value setting section that sets a threshold value for each of the communication sections for determining a quality of signals received by the each of the communication sections from a base station; a determination section that determines whether or not each of the communication sections can communicate based on the threshold value; and a modification section that changes to a different threshold value set by the threshold value setting section when it is determined by the determination section that in at least two of the communication sections can communicate and when a hand-off occurs in one of the communication sections.

Priority is claimed on Japanese Patent Application No. 2003-204796, filed Jul. 31, 2003, the content of which is incorporated herein by reference.

### TECHNICAL FIELD

The present invention relates to a wireless communication terminal that communicates with a plurality of communication systems by means of a single RF control unit.

### BACKGROUND ART

A hybrid wireless communication terminal that has a single RF control unit used for two communication systems functions by switching the RF control unit between the communication systems to be used as appropriate when the terminal is within an area in which the terminal can communicate (i.e., within a reception area) with the two systems. This is called a hybrid operation. As shown in FIG. 4, when the terminal is in a waiting status waiting for incoming calls from the two communication systems, intermittent reception is conducted so that the terminal does not communicate with the two communication systems simultaneously. The hybrid wireless communication terminal performs switching of the RF control unit when a communication system currently employed is put in a sleep mode in order not to affect the operation of the terminal. Furthermore, Japanese Unexamined Patent Application, First Publication No. H11-346170 discloses a technique in which reception from two communication systems is allowed using a single antenna.

However, in the above-described technique, when switching between base stations in a waiting status (idle hand-off) occurs in one communication system, the RF control unit cannot switch to another communication system while the RF control is executing this hand-off.

An idle hand-off occurs when there is a base station that sends the hybrid wireless communication terminal pilot signals having a better communication quality than communication quality of pilot signals transmitted by a base station currently being monitored. Assume a case in which idle hand-offs occur frequently in one communication system in the vicinity of a border of service areas or the like. This scenario is not problematic since a call cannot be originated using another communication system when that communication system is out of a reception area. However, when two communication systems are within a reception area, a call cannot be originated for a long time in one communication system since the RF control unit cannot switch to that communication system in which no idle hand-off occurs while an idle hand-off is occurring in another communication system (see FIG. 5).

In that case, the RF control unit cannot be used for a long time for that communication system in which making a call is desired since another communication system in which making a call is not desired is using the RF control unit.

### DISCLOSURE OF THE INVENTION

The present invention was conceived in view of the above-mentioned situations, and an object thereof is to provide a wireless communication terminal in which idle hand-offs occurs infrequently when two communication systems supported by the hybrid terminal are within a reception area and when idle hand-offs frequently occur.

To achieve the above-described object, a wireless communication terminal according to a first aspect of the present invention includes: a plurality of communication sections, each of the communication sections communicating with one of a plurality of communication systems; a threshold value setting section that sets a threshold value for each of the communication sections for determining a quality of signals received by the each of the communication sections from a base station; a determination section that determines whether or not each of the communication sections can communicate based on the threshold value; and a modification section that changes to a different threshold value set by the threshold value setting section when it is determined by the determination section that in at least two of the communication sections can communicate and when a hand-off occurs in one of the communication sections.

According to a second aspect of the present invention, the above-described wireless communication terminal may further include a calculation section that calculates an occurrence frequency of a hand-off for each of the communication sections, and the modification section may change to a different threshold value set by the threshold value setting section when the occurrence frequency calculated by the calculation section exceeds a predetermined value.

According to a third aspect of the present invention, in the above-described wireless communication terminal, the occurrence frequency calculated by the calculation section may be based on the number of occurrences of a hand-off in a waiting status.

According to a fourth aspect of the present invention, in the above-described wireless communication terminal, the occurrence frequency calculated by the calculation section may be based on an occurrence time of a hand-off per unit time.

### BRIEF DESCRIPTION OF THE DRAWINGS

FIG. 1 is a block diagram illustrating a schematic configuration of a hybrid terminal 1 according to an embodiment of the present invention.

FIG. 2 is a flowchart illustrating an operation for setting initials value used to determine the occurrence of an idle hand-off of the hybrid terminal 1 in this embodiment.

FIG. 3 is a flowchart illustrating operation of the hybrid terminal 1 when an idle hand-off occurs in this embodiment.

FIG. 4 is a timing chart of the waiting status from the two communication systems in a hybrid terminal.

FIG. 5 is a timing chart upon occurrence of an idle hand-off of the two communication systems in the hybrid terminal.

### BEST MODE FOR CARRYING OUT THE INVENTION

Hereinafter, preferred embodiments of the invention will be described with reference to the drawings. However, it should not be construed that the present invention is limited to these embodiments; rather, components of these embodiments may be combined if necessary.

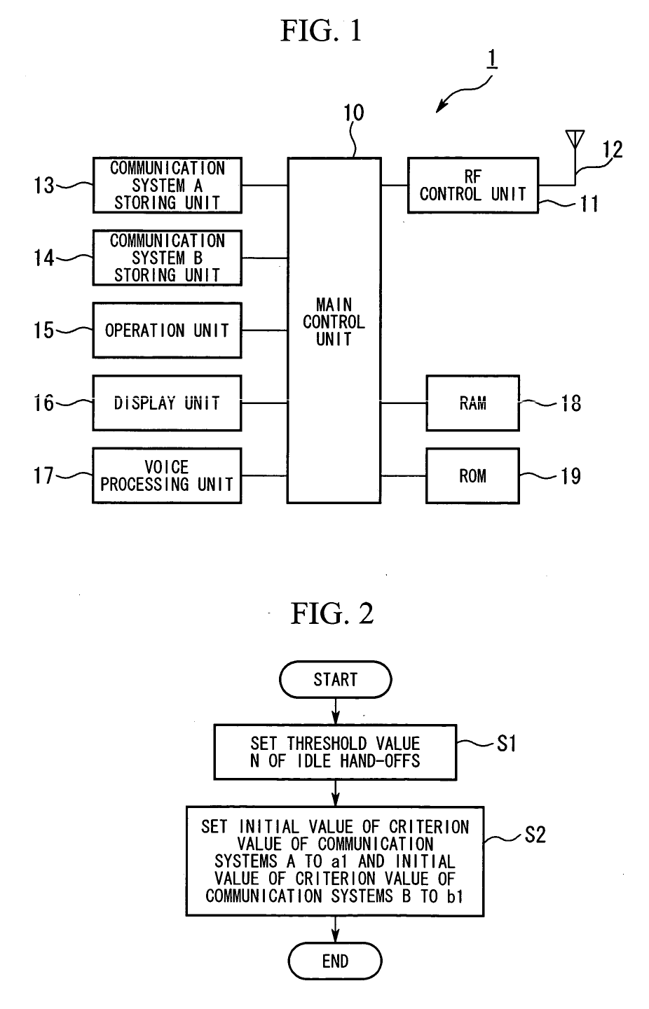

FIG. 1 is a block diagram illustrating a schematic configuration of a hybrid wireless communication terminal 1 according to an embodiment of the present invention. Reference numeral 10 denotes a main control unit (a threshold value setting section, a determination section, a modification section, and a calculation section) which controls respective portions of the hybrid wireless communication terminal 1. Reference numeral 11 denotes an RF control unit (a communication section) which controls voice communication or data communication conducted via an antenna 12. Reference numeral 13 denotes a storing unit that stores settings for a communication system A and reference numeral 14 denotes a storing unit that stores settings for a communication system B, in which information related to various protocols, operational frequency bandwidths, or the like is stored beforehand. Reference numeral 15 denotes an operation unit for making key inputs, reference numeral 16 denotes a display unit, and reference numeral 17 denotes a voice processing unit. Reference numeral 18 denotes a RAM (random access memory) for temporally storing data, and reference numeral 19 denotes a ROM (read only memory) that stores an operation program of the main control unit 10.

An exemplary combination of wireless communication systems A and B used for the wireless communication terminal of the present invention may be the TACS and the CDMA that are described in Japanese Unexamined Patent Application, First Publication No. H11-346170. However, the present invention is not limited to this, and other combinations, for example, the CDMA2000 1x and CDMA2000 1xEV-DO, may be used. Furthermore, the number of communication systems is not limited to two, and three or more communication systems may be possible.

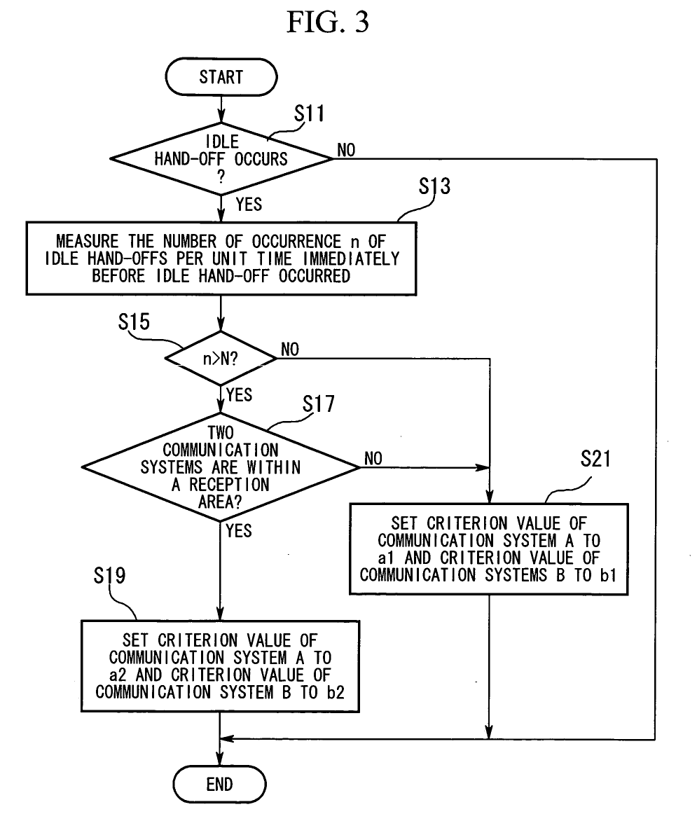

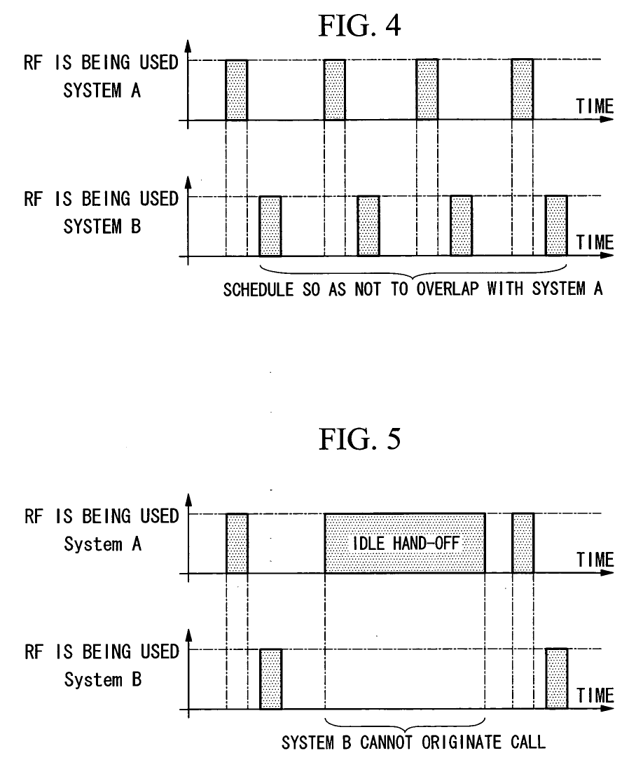

Next, operations of the hybrid terminal 1 having the configuration described above will be explained with reference to FIG. 2 and FIG. 3. First, an operation for setting initial values used for determining the occurrence of an idle hand-off will be explained with reference to FIG. 2.

Using the operation unit 15, a user sets a threshold value N of the number of occurrences of an idle hand-off per unit time (step S1). The main control unit 10 stores a threshold value N that was set into the RAM 18. The user also enters a1 and b1 as initial values of criterion values of the communication systems A and B using the operation unit 15 (step S2). The main control unit 10 stores the criterion values a1 and b1 that were entered into the storing units 13 and 14, respectively. It should be noted that these values may have been set by default without the user's intervention to enter or set them.

As used herein, the above-described criterion values are threshold values for switching from a base station currently being monitored to another base station (i.e., hand-off), and they are threshold values for evaluating the communication quality of pilot signals transmitted from a base station to the hybrid terminal 1, such as the CIR (Carrier to Interference ratio) or the RSSI (Received Signal Strength Indicator).

If a criterion value for a certain communication system is set to a small value, the area in which communication can be conducted with a base station currently being monitored becomes small and the occurrence frequently of an idle hand-off is increased. In contrast, if the criterion value for the communication system is set to a large value, the area in which communication can be conducted with the base station currently being monitored becomes large. Thus, communication can be conducted via that base station even in an area in which the communication quality is not satisfactory, accordingly, and the occurrence frequently of an idle hand-off is reduced.

Next, an operation of the hybrid terminal 1 upon occurrence of an idle hand-off will be explained with reference to FIG. 3. The hybrid terminal 1 is communicating with a base station in either one of the communication systems A and B. When an idle hand-off occurs in the system being used for communication (“Yes” in step S11), the main control unit 10 measures a number of occurrences “n” of an idle hand-off per unit time immediately before the idle hand-off occurred (step S13). When the measured number of occurrences “n” is greater than the threshold value N that was set in step S1 shown in FIG. 2 (“Yes” in step S15), the main control unit 10 considers that idle hand-offs occur frequently.

At that time, when both of the two communication systems are within a reception area (“Yes” in step S17), the main control unit 10 raises the criterion value of the communication system A to a2 (a2>a1) and the criterion value of the communication system B to b2 (b2>b1), and updates the respective criterion values stored into the storing units 13 and 14 (step S19). Alternatively, only the criterion value of the communication system in which idle hand-offs occur frequently may be raised.

When the measured number of occurrences “n” of an idle hand-off is smaller than the threshold value N (“No” in step S15) or when either one of the two communication systems is out of a reception area (“No” in step S17), the main control unit 10 sets the criterion values of the communication systems A and B to their respective initial values, and updates the respective criterion values stored into the storing units 13 and 14 (step S21).

As described previously, according to this embodiment, in a hybrid terminal, when idle hand-offs frequently occur in a one communication system being used for communication, the criterion values are set to higher value to reduce the occurrence of idle hand-offs. Thus, a situation can be prevented in which an RF control unit is used for one communication system due to frequent occurrence of idle hand-offs and a call cannot be originated in another communication system which is also within a reception area.

Furthermore, when either one of the communication systems is within a reception area, the call incoming rate is maintained constant since the threshold value is not changed.

Although an embodiment of the present invention has been described with reference to the drawings, the specific configuration is not limited to this embodiment. Variants of design can be envisaged which do not exceed the scope of the present invention.

For example, the configuration is used in which the condition for determining frequent occurrence of idle hand-offs is the number of occurrences of an idle hand-off in the above-described embodiment. However, the present invention is not limited to this, and a configuration may be used in which whether or not idle hand-offs occur frequently is determined based on the time of the occurrence of idle hand-offs.

Furthermore, a configuration may be used in which the number of occurrences of an idle hand-off per unit time and criterion values corresponding to the number of occurrences are arranged in a table which is stored in the RAM of the hybrid terminal, and criterion values are retrieved by looking up the table after measurement of the number of occurrences of an idle hand-off.

Furthermore, the present invention can be applied portable telephones, which are wireless communication terminals in the above-described embodiment, or portable personal computers and personal digital assistants (PDAs) having wireless communication capability, or wireless communication modules, or the like.

As is apparent from the description above, according to the present invention, communication can be conducted using at least two or more communication systems. Since a threshold value for determining the quality of signals received from a base station is changed when the occurrence frequency of a hand-off is greater than a predetermined value in one communication system, frequent occurrence of idle hand-offs in that communication system can be prevented during a hybrid operation. As a result, a situation can be prevented in which an RF control unit is occupied by that communication system.

1. A wireless communication terminal comprising:
a plurality of communication sections, each of the communication sections communicating with one of a plurality of communication systems;
a threshold value setting section that sets a threshold value for each of the communication sections for determining a quality of signals received by the each of the communication sections from a base station;
a determination section that determines whether or not each of the communication sections can communicate based on the threshold value; and
a modification section that changes to a different threshold value set by the threshold value setting section when it is determined by the determination section that in at least two of the communication sections can communicate and when a hand-off occurs in one of the communication sections.

2. The wireless communication terminal according to claim 1, further comprising a calculation section that calculates an occurrence frequency of a hand-off for each of the communication sections,
wherein the modification section changes to a different threshold value set by the threshold value setting section when the occurrence frequency calculated by the calculation section exceeds a predetermined value.

3. The wireless communication terminal according to claim 2, wherein the occurrence frequency calculated by the calculation section is based on the number of occurrences of a hand-off in a waiting status.

4. The wireless communication terminal according to claim 2, wherein the occurrence frequency calculated by the calculation section is based on an occurrence time of a hand-off per unit time.
